(19) United States
(12) Patent Application Publication
(10) Pub. No.: US 2002/0174429 A1
(43) Pub. Date: Nov. 21, 2002

(54) Methods and apparatus for generating recommendation scores

(76) Inventors: Srinivas Gutta, Buchanan, NY (US); Kaushal Kurapati, Yorktown Heights, NY (US); David J. Schaffer, Wappingers Falls, NY (US)

Correspondence Address: Corporate Patent Counsel, Philips Electronics North America Corporation, 580 White Plains Road, Tarrytown, NY, 10591, US

(21) Appl. No.: 09/821,277

(22) Filed: Mar. 29, 2001

(51) Int. Cl. G06F 3/00; H04N 5/445; G06F 13/00

(52) U.S. Cl. 725/46; 725/39; 725/44

(57) ABSTRACT

Methods and apparatuses for recommending television programs are provided. The methods provided include obtaining a list of one or more television programs to at least three different program recommenders, obtaining from each recommender a recommendation score, and computing a combined recommendation score by applying a voting process. The combined recommendation score is then presented to a user, who, based thereon, can select a television program of interest. The voting process is a stochastic method including a Bayesian method, a hierarchical decision tree, a memory based learning process, a rule based learning process, a neural network or a hidden markov model. The enumerated stochastic processes can be further combined according to a combination scheme including a unison scheme, a majority scheme, a trust scheme, an averaging scheme or mixture thereof.

### FIELD OF THE INVENTION

The present invention relates to methods and apparatus for recommending television programming, and more particularly, to techniques for generating recommendation scores using viewer preferences and by applying voting processes.

### BACKGROUND OF THE INVENTION

As the number of channels available to television (TV) viewers has increased, along with the diversity of the programming content available on such channels, it has become increasingly challenging for television viewers to identify television programs of interest. Historically, television viewers identified television programs of interest by analyzing printed television program guides. Typically, such printed television program guides contained grids listing the available television programs by time and date, channel and title. As the number of television programs has increased, it has become increasingly difficult to effectively identify desirable television programs using such printed guides.

More recently, television program guides have become available in an electronic format, often referred to as electronic program guides (EPGs). Like printed television program guides, EPGs contain grids listing the available television programs by time and date, channel and title. Some EPGs, however, allow television viewers to sort or search the available television programs in accordance with personalized preferences. In addition, EPGs allow for on-screen presentation of the available television programs.

While EPGs allow viewers to identify desirable programs more efficiently than conventional printed guides, they suffer from a number of limitations, which if overcome, could further enhance the ability of viewers to identify desirable programs. For example, many viewers have a particular preference towards, or bias against, certain categories of programming, such as action-based programs or sports programming. Viewer preferences, therefore, can be applied to EPGs to obtain a set of recommended programs that may be of interest to a particular viewer.

Thus, a number of tools have been proposed for recommending television programming also known as television program recommenders. The Tivo™ system, for example, commercially available from Tivo, Inc., of Sunnyvale, Calif., allows viewers to rate shows using a “Thumbs Up and Thumbs Down” feature and thereby indicate programs that the viewer likes and dislikes, respectively. Thereafter, the Tivo receiver matches the recorded viewer preferences with received program data, such as an EPG, to make recommendations tailored to each viewer.

In a system such as the Tivo™ system, the user provides feedback data to rank a choice as liked or disliked and optionally to a degree. Generally, the viewer rates programs that are both liked and disliked so that both positive and negative feedback is obtained.

Conventional implicit television program recommenders generate television program recommendations based on information derived from the viewing history of the viewer, in a non-obtrusive manner. An implicit television recommender attempts to derive the viewing habits of the viewer based on the set of programs that the viewer liked or disliked.

Examples of implicit recommenders are described in related applications U.S. Ser. No. 09/466,406 filed Dec. 17, 1999 (Attorney Docket No. 700772) entitled “Method and Apparatus for Recommending Television Programming Using Decision Trees” and U.S. Ser. No. 09/498,271 filed Feb. 4, 2000 (Attorney Docket No. 700690) entitled “Bayesian TV Recommender”, each assigned to the assignee of the present invention and incorporated herein by reference for all they disclose.

Conventional explicit television program recommenders, on the other hand, explicitly question viewers about their preferences for program attributes, such as title, genre, actors, channel and date/time, to derive viewer profiles and generate recommendations. An explicit television program recommender processes the viewer survey, in a known manner, to generate an explicit viewer profile containing a set of rules that implement the preferences of the viewer.

While such television programs recommenders identify programs that are likely of interest to a given viewer, they suffer from a number of limitations, which when overcome, further improve the quality of the generated program recommendations. For example, explicit television program recommenders typically do not adapt to the evolving preferences of a viewer. Similarly, implicit television program recommenders often make improper assumptions about the viewing habits of a viewer that could have easily been identified explicitly by the viewer.

As a result of shortcomings present in recommenders based on only one type of data such as feedback, implicit or explicit data, more complex recommenders have been developed where recommendation scores are derived by using all three types of viewer preferences. Examples of such recommenders are described in related applications U.S. Ser. No. 09/627,139 filed Jul. 27, 2000 (Attorney Docket No. 700913) entitled “Three-Way Media Recommendation Method and System” and U.S. Ser. No. 09/666,401 filed Sep. 20, 2000 (Attorney Docket No. 701247) entitled “Method and Apparatus for Generating Recommendation Scores Using Implicit and Explicit Viewing Preferences” incorporated herein by reference as if set forth in full.

While television program recommenders based on combining implicit and explicit viewer preferences represent an improvement over recommenders based only on one type of viewer preferences, they also suffer from limitations. For example, when implicit and explicit groups of the recommender are combined internally by using a weighting scheme the overall predictive performance is improved, however, the false positive rate is shown on receiver operating curves (ROCs) also increases.

A need therefore still exists for a method and a system for generating program recommendations based on the use of hybrid methodologies integrating multiple paradigms. Additionally, there is also a need to provide a method and a system for generating program recommendation based on different types of television program recommenders such that errors are reduced and a higher performance is realized.

### OBJECTS OF THE INVENTION

It is, therefore, an object of the present invention to provide a method for recommending television programming in which different methodologies associated with different type of television programming recommenders are complementary to each other.

It is a further object of the invention to provide systems based on the use of hybrid methodologies in integrating multiple paradigms generating television recommendations.

### SUMMARY OF THE INVENTION

The present invention, which addresses the needs of the prior art, provides methods for recommending television programs. One method includes obtaining a list of one or more television programs; providing the list of programs to at least three different program recommenders, R₁, R₂ and R₃; obtaining for each program on the list a set of recommendation scores, S₁, S₂ and S₃, from each of the recommenders, R₁, R₂ and R₃; generating for each program on the list a combined recommendation score, C, computed by applying a voting process to each of the recommendation scores S₁, S₂ and S₃; and recommending the program to a user by presenting the combined recommendation score, C, to the user. The recommendation scores S₁, S₂ and S₃ can be implicit recommendation scores I₁, I₂ and I₃. The voting process can be based on a stochastic method including a Bayesian method, a hierarchical decision tree method, a memory based learning process, a rule based learning process, a neural network, or a hidden markov model. The previous enumerated stochastic methods can be further combined according to a combination scheme including a unison scheme, a majority scheme, a trust scheme, an averaging scheme or mixtures thereof. The recommendation score, C, obtained according to the methods of the present invention enables the user to select a television program of interest.

Another method of recommending television programs provided by the present invention, also includes generating at least one explicit recommendation score, E, for each television program; generating a combined recommendation score, Cₑ, computed by applying a voting process to each of the implicit recommendation scores and the explicit recommendation score.

In another method, it is possible to also generate at least a feedback score for the one or more television programs; and then generate a combined recommendation score, C_{f}, computed by applying a voting process to each of the implicit recommendation scores, the explicit recommendation score and the feedback score.

As in other embodiments of the present invention the voting process is based on a stochastic method which includes a Bayesian method, a hierarchical decision tree method, a memory based learning process, a rule based learning process, a neural network, or a hidden markov model. These stochastic methods can be further combined through a combination scheme including a unison scheme, a majority scheme, a trust scheme, an averaging scheme or a mixture thereof.

In another embodiment of the invention a method for recommending the television programs includes obtaining a list of one or more television programs; obtaining at least an explicit recommendation score, E, for the one or more television programs; obtaining at least an implicit recommendation score, I, for the one or more television programs; obtaining at least a feedback recommendation score, F, for the one or more television programs; generating for each television program a combined recommendation score, C, based on applying a voting process to each of the explicit recommendation score, the implicit recommendation score and the feedback recommendation score; and recommending the combined recommendation score, C, to a user for presenting the recommendation score, C, to the user. Again, the voting process useful for this embodiment of the present invention is a stochastic process including a Bayesian method, a hierarchical decision tree method, a memory based learning process, a rule based learning process, a neural network or a hidden markov model. These stochastic methods are further combined according to a combination scheme including a unison scheme, a majority scheme, a trust scheme, an averaging scheme or a mixture thereof. The combined recommendation score, C, enables the user to select a television program of interest.

The present invention also provides a system for obtaining a recommendation for a television program for a user, the system comprising a memory for storing computer readable code; and a processor operatively coupled to the memory, the processor configured to: obtain a list of one or more television programs; provide the list of television programs to at least two program recommenders, R₁, R₂ and R₃; obtain for each television program on the list a set of recommendation scores, S₁, S₂ and S₃ from each of the recommenders, R₁, R₂ and R₃; generate for each program on the list a combined recommendation score, C, computed by applying a voting process to each of the recommendation scores S₁, S₂ and S₃; and recommending the combined recommendation score, C, by presenting the combined recommendation score, C, to a user.

As in the other methods above, the voting process is based on a stochastic method including a Bayesian method, a hierarchical decision tree method, a memory based learning process, a rule based learning process, a neural network or a hidden markov model. These stochastic processes are further combined according to a combination scheme including a unison scheme, a majority scheme, a trust scheme, an averaging scheme, or a mixture thereof.

In yet another embodiment the present invention provides a system for obtaining a recommendation for a television program for a user which includes a memory for storing computer readable code; and a processor operatively coupled to the memory, the processor configured to: obtain a list of one or more television programs; obtain at least an explicit recommendation score, E, for the one or more television programs; obtain at least an implicit recommendation score, I, for the one or more television programs; obtain at least a feedback recommendation score, F, for the one or more television programs; generate a combined recommendation score, C, based on applying a voting process to each of the explicit recommendation score, the implicit recommendation score and the feedback recommendation score; recommending the combined recommendation score, C, thus obtained to a user, to enable the user to select a television program of interest. The voting process utilized in this method is based on a stochastic method including a Bayesian method, a hierarchical decision tree method, a memory based learning process, a rule based learning process, a neural network or a hidden markov model. As before, the stochastic process is useful for this method are combined according to a combination scheme including a unison scheme, a majority scheme, a trust scheme, an averaging scheme, or a mixture thereof.

As a result of the present invention television recommenders with different methodologies are used to provide a combined recommendation which has fewer errors and achieves a higher performance than that of each individual recommender.

Other improvements which the present invention provides over the prior art will be identified as a result of the following description which set forth the preferred embodiments of the present invention. The description is not in any way intended to limit the scope of the present invention, but rather only to provide the working example of the present preferred embodiments. The scope of the present invention will be pointed out in the appended claims.

### BRIEF DESCRIPTION OF THE DRAWINGS

FIG. 1 is a flow chart describing a television program recommendation method arrived at by combining a set of recommendation scores S₁, S₂ and S₃ according to a combination voting scheme.

FIG. 2 is a flow chart describing a television program recommendation method arrived at by combining nine recommendation scores obtained from three types of recommenders, implicit, explicit and feedback.

FIG. 3 is a flow chart illustrating a television program recommendation method arrived at by combining separately scores obtained from implicit, explicit and feed back recommenders, followed by a further combination voting scheme of scores obtained from the first combination voting scheme.

FIG. 4 is a flow chart illustrating a television program recommendation method arrived at by applying a stochastic method of voting to all scores.

FIG. 5 illustrates receiver operating curves (ROCs) for recommendation scores for user A (usr A) using one recommender as in implicit Bayesian (IB), implicit decision tree (IDT) and explicit (E) for an individual (indiv) and household (house), and combined score recommenders as in implicit Bayesian and explicit (IB+E) and implicit decision tree and explicit (IDT+E) for individual and household.

FIG. 6 illustrates a receiver operating curve for a household user (usr H) using one recommender as in implicit Bayesian (IB), implicit decision tree (IDT) and explicit (E) for an individual (indiv) and household (house), and combined score recommenders as in implicit Bayesian and explicit (IB+E) and implicit decision tree and explicit (IDT+E) for an individual and household.

FIG. 7 illustrates ROCs for user A employing a voting process applied to three single recommenders IB, IDT and explicit, E, and two combined recommenders IB+E and IDT+E for an individual and household.

FIG. 8 illustrates ROCs for user H employing a voting process applied to three single recommenders IB, IDT and explicit, E, and two combined recommenders IB+E and IDT+E for an individual and household.

### DETAILED DESCRIPTION OF THE INVENTION

The present invention is a method for recommending television programs. More specifically, the method includes obtaining a list of one or more programs; providing the list of programs to at least three different program recommenders, R₁, R₂ and R₃, from which a set of recommendation scores S₁, S₂ and S₃ is obtained; generating a combined recommendation score, C, computed by applying a voting process to each of the recommendation scores S₁, S₂ and S₃; and presenting the combined recommendation score to a user for use in selecting or taping television programs.

The recommendation scores S₁, S₂ and S₃ can be provided by many types of recommenders, for example, recommenders based on feedback, implicit and explicit data. As used herein “feedback data” refers to data derived from ratings provided by user with respect to a particular resource in the EPG; “implicit data” is data derived from machine-observation of a user's viewing history, whereby the implicit data reflects the user's selections of programs to view; and “explicit data” is data indicating express recommendations by a user of preferred classes of programming rather than indicators by the user of particular resources that are preferred.

Combining recommendation scores provided by different types of recommenders has been devised because it has been found that combined scores consistently outperform a single best recommender. Television program recommenders can be considered similar to classifiers of pattern recognition systems. A theoretical underpinning of existing classifier combination schemes applicable to television program recommenders is provided by Kittler, J., et al. in “Combining Classifiers”, 13th International Conference on Pattern Recognition, pp. 897-901 (1996).

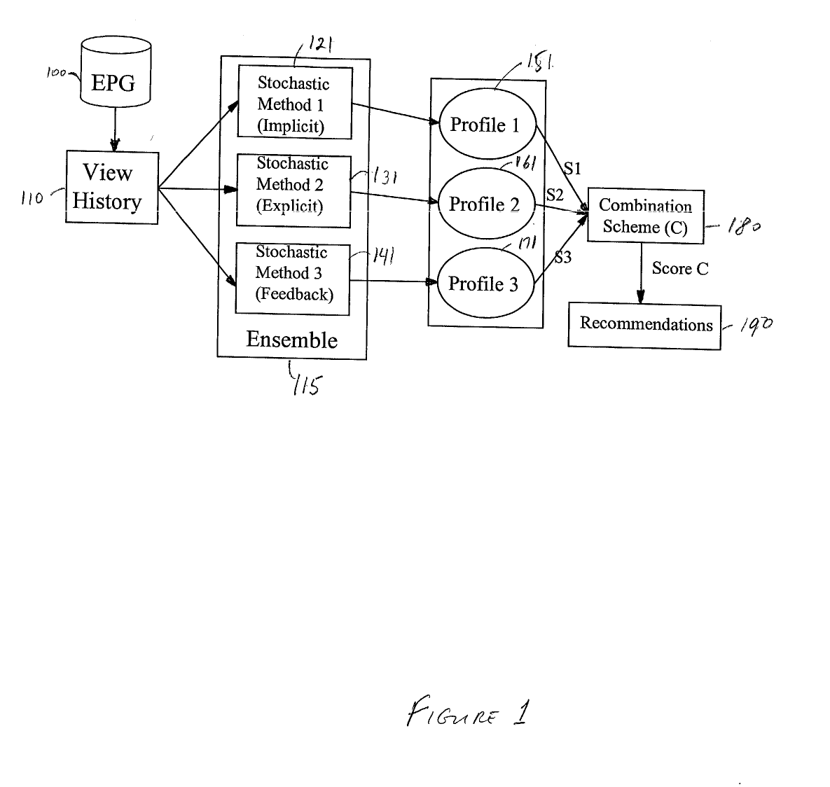

It has been unexpectedly found that a combined recommendation score obtained by applying a voting process to each of the recommendation scores S₁, S₂ and S₃ obtained from at least three different types of television program recommenders has a superior predictive performance and substantially decreased false positive rates as shown on ROC curves. FIG. 1 illustrates an embodiment of the present invention wherein the recommendation scores S₁, S₂ and S₃ are combined through a voting process.

There are many voting processes useful for the methods of the present invention. Preferably, the voting process applied to recommendation scores provided by television program recommenders is based without limitations on stochastic methods. Most preferably the stochastic methods are broadly selected from methods including a Bayesian method, a hierarchical decision tree method, a memory based learning process, a rule based learning process, a neural network, or a hidden markov model. The following schemes can be used to create mixtures of the above stochastic methods, including without limitation, a unison scheme, a majority scheme, a trust scheme, an averaging scheme and mixtures thereof

The stochastic methods useful in the voting process of the present invention are well known in the art, and are more particularly defined and described by Battitti, R., et al. in “Democracy in Neural Nets: Voting Schemes for Classification”, Neural Networks, vol. 7, no. 4, pp. 691-707 (1994), incorporated herein by reference for all it discloses.

In one aspect of the invention, the recommendation scores S₁, S₂ and S₃ are implicit recommendation scores I₁, I₂ and I₃, generated by providing implicit data to an implicit data recommender.

In another aspect of the present invention, a combined recommendation score, C_{f}, is computed by applying a voting process to recommendation scores provided not only by recommenders of implicit recommendation scores but also by recommenders of explicit and feedback scores.

An explicit recommendation score, E, is generated based on attribute values set forth in an explicit viewer profile. Explicit recommendation score, E and implicit recommendation scores I, can be calculated as more particularly described in U.S. patent application Ser. No. 09/664,401, filed Sep. 20, 2000 (Attorney Docket No. 701247) entitled “Method and System for Generating Explicit Recommendation Scores and for Combining Them With Implicit Recommendation Scores” assigned to the assignee of the present invention and incorporated by reference herein as if set forth in full.

Another aspect of this invention concerns providing a system for obtaining a recommendation for a television program having conventional attributes for use by a viewer. The system includes a memory for storing computer readable codes and a processor operatively coupled to the memory. The processor is configured to accomplish certain tasks including, but not limited to obtaining a list of one or more programs wherein the combined recommendation Cᵢ is generated by applying a voting process to each of the at least three implicit recommendation scores, I₁, I₂ and I₃.

In yet another embodiment of the present invention, the processor is configured to accomplish other tasks such as obtain a list of one or more programs; obtain at least an explicit recommendation score, E, for said one or more programs; obtain at least an implicit recommendation score, I, for the list of one or more programs; obtain at least a feedback recommendation score, F, for the list of one or more programs; generate a combined recommendation score, C, based on applying a voting process to each explicit recommendation score, implicit recommendation score and feedback recommendation score.

In all systems provided by the present invention, the voting process is broadly based on a stochastic method selected from methods including a Bayesian method, a hierarchical decision tree method, a memory based learning process, a rule based learning process, a neural network, a hidden markov model. These methods can be used to create mixtures of the above methods, including without limitation, a unison scheme, a majority scheme, a trust scheme, an averaging scheme or mixtures thereof.

FIG. 1 illustrates one embodiment of the present invention wherein the program recommendation method includes providing a source of one or more television programs (EPG) 100 for developing a viewer history 110 to which an assembly 115 of stochastic methods 121, 131, and 141 are applied by implicit, explicit and feedback TV recommenders (not shown) in order to obtain user profiles 151, 161, 171. The TV recommenders generate scores S₁, S₂ and S₃ which are combined through a combination voting scheme, as discussed above, to yield a final recommendation score C for use by the user as recommendations 190.

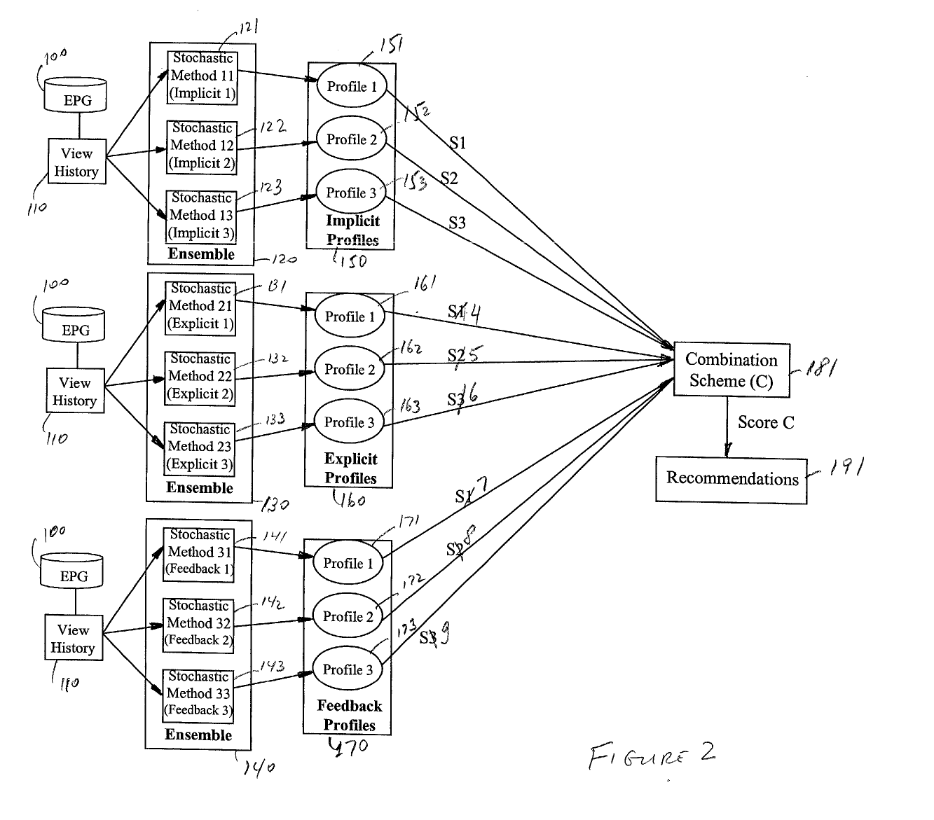

Another embodiment of the present invention is illustrated in FIG. 2. In the method of FIG. 2 multiple scores are obtained from at least three implicit TV recommenders (not shown) by applying three different stochastic methods, 121, 122 and 123, thereby obtaining three different implicit user profiles 151, 152, 153. Each implicit TV recommender generates an implicit score S₁, S₂ and S₃. Similarly, an ensemble 130 of explicit recommenders apply stochastic methods 141, 142, 143 to obtain three different explicit user profiles 161, 162, 163. Each explicit TV recommender generates an explicit score S₄, S₅ and S₆. Additionally, an ensemble 140 of feedback TV recommenders apply stochastic methods to obtain three different feedback user profiles 171, 172, 173 used by the TV recommenders to generate scores S₇, S₈ and S₉. All the scores are thereafter combined by voting through a combination scheme of the type discussed above to generate a combined score C to provide the user with recommendations 181. The user then uses recommendations 181 to select programs of interest.

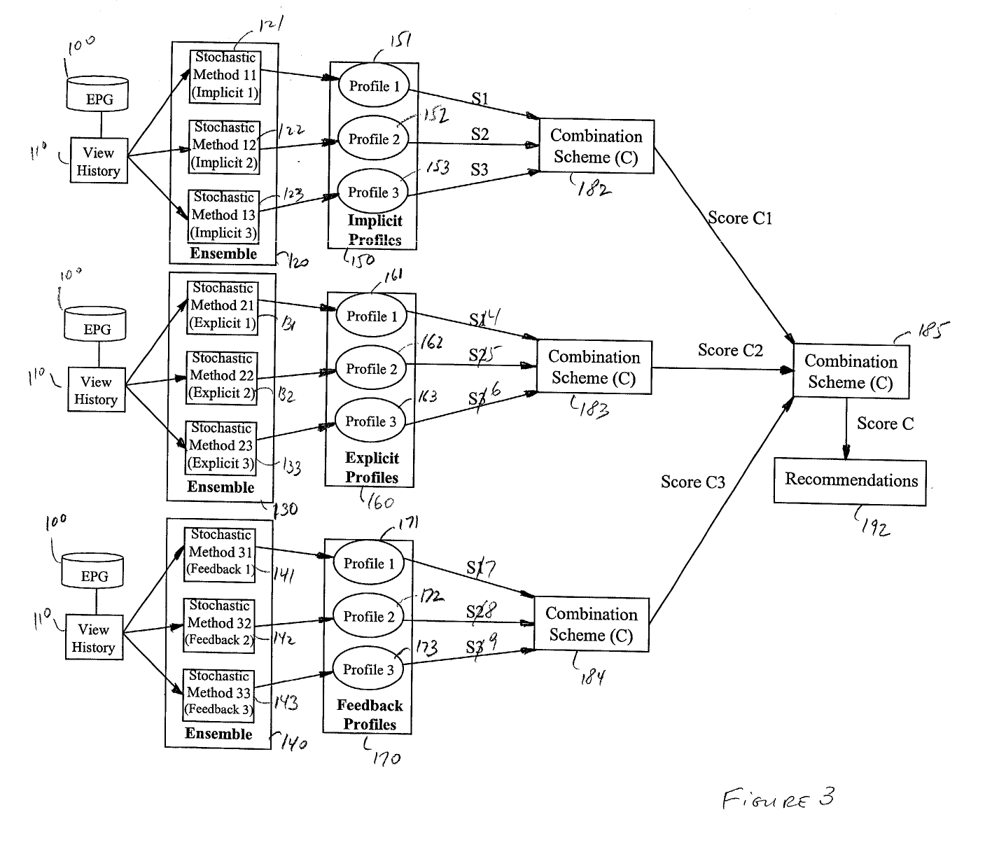

Another aspect of the present invention is illustrated in FIG. 3. In this method implicit scores S₁, S₂, S₃, explicit scores S₄, S₅, S₆ and feedback scores S₇, S₈, S₉ are obtained as in the method illustrated in FIG. 2. To each type of score, implicit, explicit and feedback, a voting process is applied through combination schemes 182, 183, 184. Three different scores C₁, C₂ and C₃ are obtained. To scores C₁, C₂ and C₃ another voting process according to a combination scheme 185 is applied in order to obtain a final score C. Recommendations 192 are thus obtained.

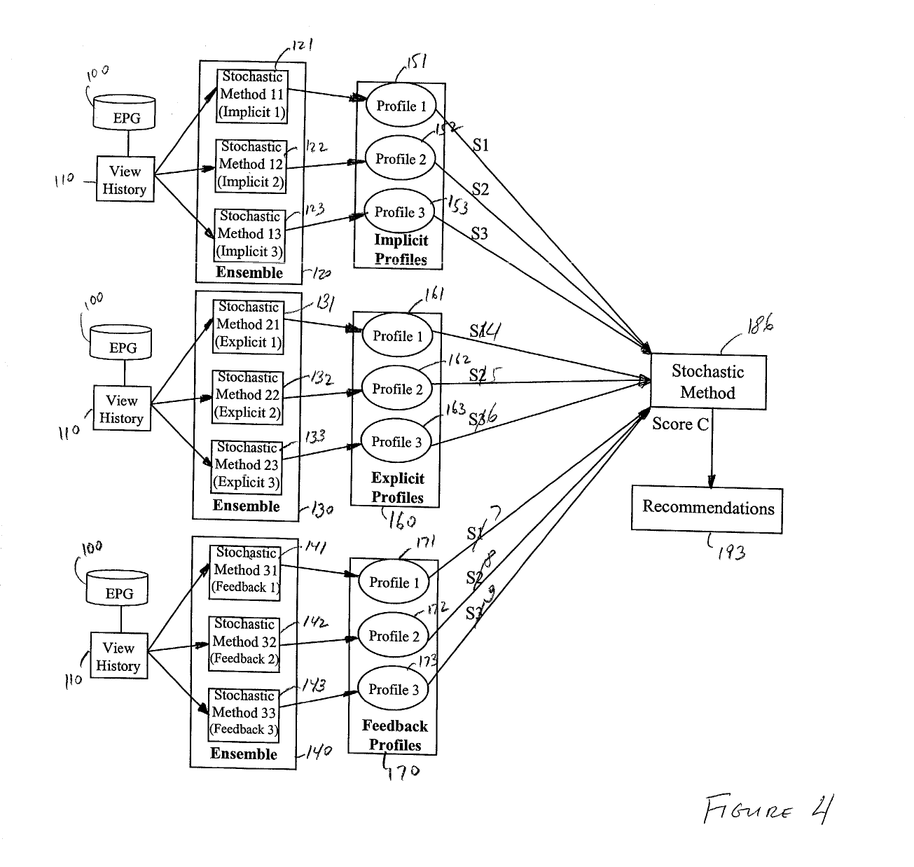

Yet another aspect of the present invention is illustrated in FIG. 4. In the method shown in FIG. 4, implicit scores S₁, S₂, S₃, explicit scores S₄, S₅, S₆ and feedback scores S₇, S₈, S₉ are obtained as in the method illustrated in FIG. 2. However, a combined score C is obtained by voting according to a stochastic method 186 applied to all of these scores. Recommendations 193 are thus obtained.

Performance of television recommenders is usually plotted as a Receiver Operating Characteristic (ROC) curve. The axes of the ROC are the false-alarm (F) rate, plotted on the horizontal axis and the hit-rate (H), plotted vertically. For every value of the F-rate from 0 to 1 the plot shows the H-rate that would be obtained to yield a particular sensitivity level. When sensitivity is nil, the ROC is the major diagonal (chance line), where the H and F rates are equal. In order to obtain the H and F rate, a confidence matrix as shown in Table 1 below is computed.

TABLE 1

| | CLASS POSITIVE | CLASS NEGATIVE |
|---|---|---|
| | (C+) | (C−) |
| Prediction Positive | True Positive (TP) | False Positive (FP) |
| (R+) | | |
| Prediction Negative | False Negative (FN) | True Negative (TN) |
| (R−) | | |

In the above table, column headings indicate the true class and row headings indicate the recommender's performance. From the above table we can next compute the hit rate and the false positive rate. Hit rate (H)=TP/(TP+FP) and False Positive (FP)=FP/(FP+TN).

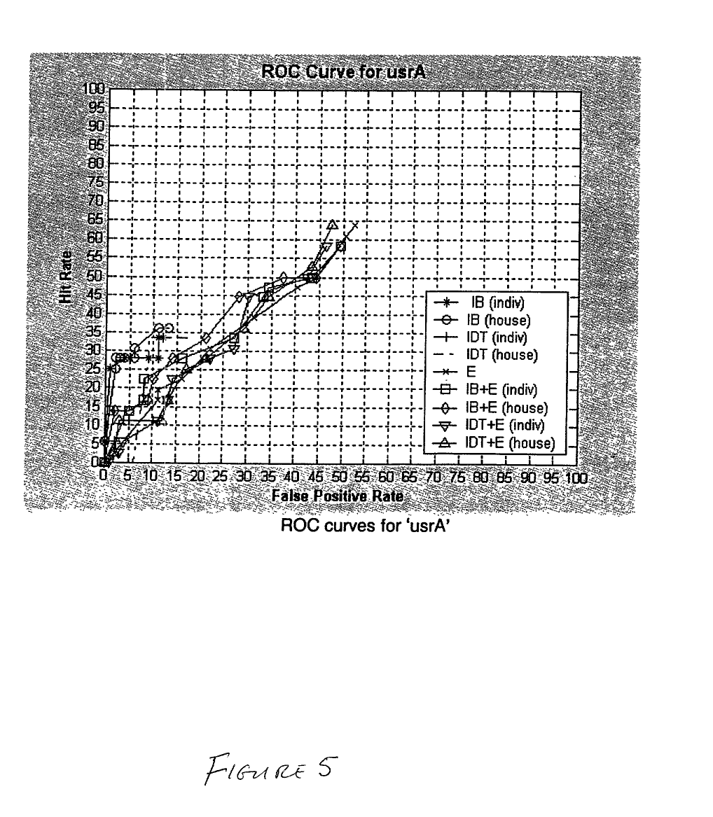

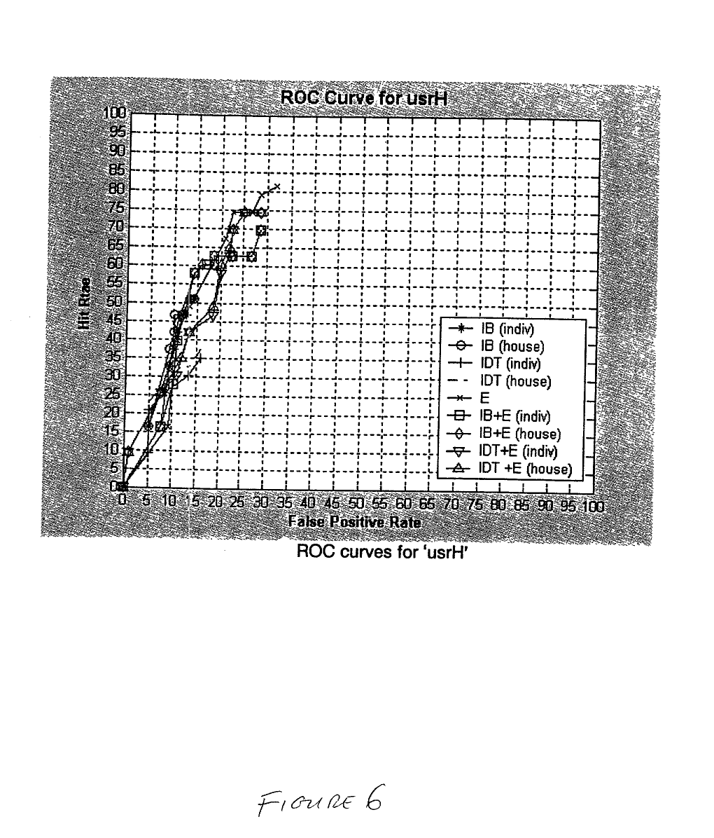

FIGS. 5 and 6 illustrate receiver operating curves (ROCs) derived from a user A (“usr A”) who had 175 shows to select from and user household (“usr H”) who had 276 shows in the viewing history. The curves are based on individual and combined recommendation scores obtained by using different types of recommenders tested on actual individual (A) or household (H). Scores from recommenders used alone as in implicit Bayesian (IB), or implicit decision tree (IDT) for an individual (indiv) or household (house) were obtained. Combined recommendation scores where the implicit Bayesian (IB) and explicit (E) as in (IB+E) were combined or implicit decision tree (IDT) and explicit (E) were combined as in IDT+E were also obtained for user A (indiv) and a household user H (house). Various ROC curves were derived by using one recommender based on Bayesian (B) or decision tree (DT) methods when used alone as in IB (indiv), IB (house), IDT (indiv), IDT (house), explicit (E) or when the recommenders have been used in combination with the explicit prong utilizing a weighting scheme as in U.S. Ser. No. 08/666,401 filed Sep. 20, 2000 (Attorney Docket No. 701247). It can be observed from FIGS. 1 and 2 that when the implicit recommenders are combined with the explicit prongs, as in IB+E individual or household or IDT+E individual or household, the overall predictive performance improves, however the false positive rates also increases. Thus, the data in FIGS. 1 and 2 provides useful comparative results.

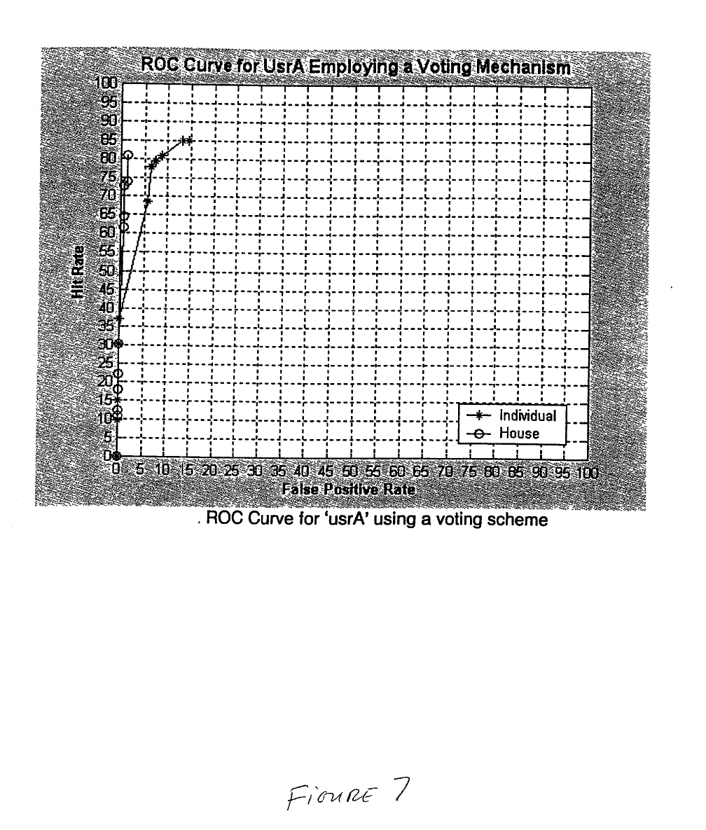

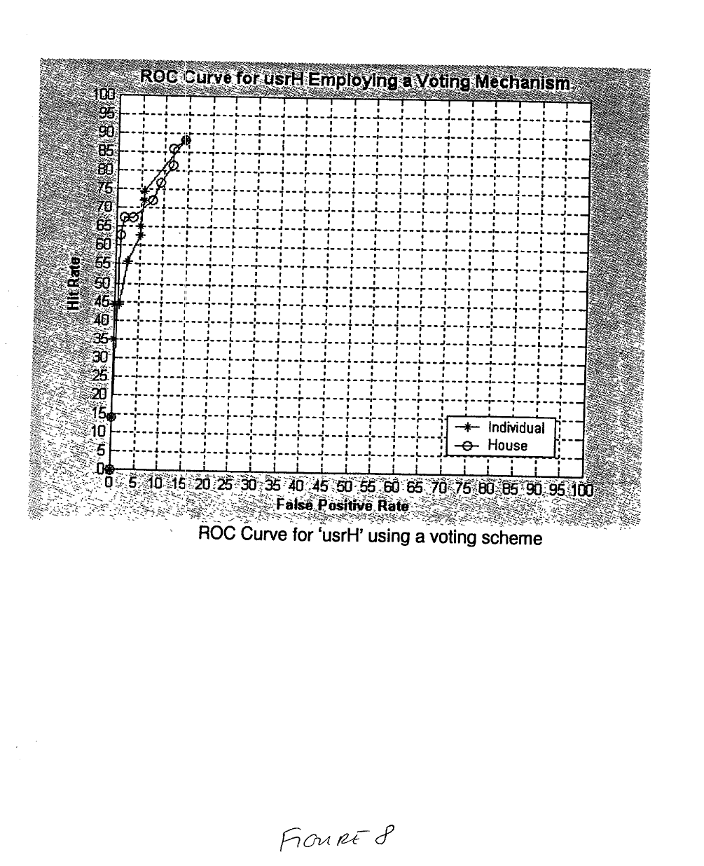

It has been unexpectedly found that when the combined recommendation scores are all combined through a voting scheme the ROC curve, the overall predictive performance is not only enhanced, but also the false positive rate score markedly decreased. For example, when the recommendation scores from five different methods, namely Bayesian, Decision Tree, Explicit scores, Implicit Bayesian and Explicit and Implicit Decision Tree and Explicit respectively obtained in FIGS. 5 and 6 are all combined through a simple voting scheme, the ROC curves as illustrated in FIGS. 7 and 8 exhibit a significant decrease in the false positive rate, on an average of from about 20% to about 35% and an increase in the hit rate from about 5% to about 20%. The voting scheme utilized to generate the ROC curves of FIGS. 7 and 8 is quite simple and is based on a method which states that if 3 out of the 5 methods described above agree on a show to be recommended, then recommend that show.

Thus, while we described what are the preferred embodiments of the present invention, further changes and modifications can be made by those skilled in the art without departing from the true spirit of the invention, and it is intended to include all such changes and modifications as come within the scope of the claims set forth below.

What is claimed is:

1. A method for recommending television programs, comprising:
obtaining a list of one or more television programs;
providing said list of programs to at least three different program recommenders, R₁, R₂ and R₃;
obtaining for each program on said list a set of recommendation scores, S₁, S₂ and S₃, from each of said recommenders, R₁, R₂ and R₃;
generating for each program on said list a combined recommendation score, C, computed by applying a voting process to each said recommendation scores S₁, S₂ and S₃; and
recommending the program to a user by presenting said combined recommendation score, C, to said user.

2. The method of claim 1, wherein said recommendation scores S₁, S₂ and S₃ are implicit recommendation scores I₁, I₂ and I₃ for said one or more programs.

3. The method of claim 2, wherein said voting process is based on a stochastic method.

4. The method of claim 3, wherein said stochastic method comprises a Bayesian method, a hierarchical decision tree method, a memory based learning process, a rule based learning process, a neural network or a hidden markov model.

5. The method of claim 4, wherein said stochastic methods are combined according to a combination scheme comprising a unison scheme, a majority scheme, a trust scheme, an averaging scheme or mixtures thereof.

6. The method of claim 1, wherein said combined recommendation score, C, enables the user to select a television program of interest.

7. The method of claim 2, further comprising generating at least an explicit recommendation score, E, for said one or more television programs; and
generating a combined recommendation score, Cₑ, computed by applying a voting process to each of said implicit recommendation scores and said explicit recommendation score, E.

8. The method of claim 7, further comprising generating at least a feedback score F, for said one or more television programs; and
generating a combined recommendation score, C_{f}, computed by applying a voting process to each of said implicit recommendation scores, said explicit recommendation score and said feedback score.

9. The method of claim 8, wherein said voting process is based on a stochastic method.

10. The method of claim 9, wherein said stochastic method comprises a Bayesian method, a hierarchical decision tree method, a memory based learning process, a rule based learning process, a neural network or a hidden markov model.

11. The method of claim 10, wherein said stochastic methods are combined according to a combination scheme comprising a unison scheme, a majority scheme, a trust scheme, an averaging scheme or a mixture thereof.

12. A method for recommending television programs, comprising:
obtaining a list of one or more television programs;
obtaining at least an explicit recommendation score, E, for said one or more television programs;
obtaining at least an implicit recommendation score, I, for said one or more television programs;
obtaining at least a feedback recommendation score, F, for said one or more television programs;
generating for each television program a combined recommendation score, C, based on applying a voting process to each said explicit recommendation score, said implicit recommendation score and said feedback recommendation score; and
recommending said combined recommendation score, C, to a user by presenting said combined recommendation score, C, to said user.

13. The method of claim 12, wherein said voting process is based on a stochastic process.

14. The method of claim 13, wherein said process comprises a Bayesian method, a hierarchical decision tree method, a memory based learning process, a rule based learning process, a neural network or a hidden markov model.

15. The method of claim 14, wherein said stochastic processes are combined according to a combination scheme comprising a unison scheme, a majority scheme, a trust scheme, an averaging scheme or a mixture thereof.

16. The, method of claim 12, wherein said combined recommendation score, C, enables said user to select a television program of interest.

17. A system for obtaining a recommendation for a television program for a user, said system comprising:
a memory for storing computer readable code; and
a processor operatively coupled to said memory, said processor configured to:
obtain a list of one or more television programs;
provide said list of television programs to at least three television program recommenders, R₁, R₂ and R₃;
obtain for each television program on said list a set of recommendation scores, S₁, S₂ and S₃ from each of said recommenders, R₁, R₂ and R₃;
generate for each television program on said list a combined recommendation score, C, computed by applying a voting process to each of said recommendation scores S₁, S₂ and S₃; and
recommending said combined recommendation score, C, by presenting said combined recommendation score, C, to a user.

18. The system of claim 17, wherein said voting process is based on a stochastic method comprising a Bayesian method, a hierarchical decision tree method, a memory based learning process, a rule based learning process, a neural network or a hidden markov model.

19. The system of claim 17, wherein said stochastic processes are combined according to a combination scheme comprising a unison scheme, a majority scheme, a trust scheme, an averaging scheme, or a mixture thereof.

20. A system for obtaining a recommendation for a television program for a user which comprises:
a memory for storing computer readable code; and
a processor operatively coupled to said memory, said processor configured to:
obtain a list of one or more television programs;
obtain at least an explicit recommendation score, E, for said one or more television programs;
obtain at least an implicit recommendation score, I, for said one or more television programs;
obtain at least a feedback recommendation score, F, for said one or more television programs;
generate a combined recommendation score, C, based on applying a voting process to each said explicit recommendation score, said implicit recommendation score and said feedback recommendation score; and
recommend said combined recommendation score, C, to a user.

21. The, system of claim 20, wherein said voting process is based on a stochastic method comprising a Bayesian method, a hierarchical decision tree method, a memory based learning process, a rule based learning process, a neural network or a hidden markov model.

22. The system of claim 21, wherein said stochastic processes are combined according to a combination scheme comprising a unison scheme, a majority scheme, a trust scheme, an averaging scheme, or a mixture thereof.
